(19) United States
(12) Patent Application Publication
(10) Pub. No.: US 2014/0067602 A1
(43) Pub. Date: Mar. 6, 2014

(54) Sanctions Screening

(71) Applicants: Sharon L. Cardazzi, Troy, NY (US); Les Morelock, Charlotte, NC (US)

(72) Inventors: Sharon L. Cardazzi, Troy, NY (US); Les Morelock, Charlotte, NC (US)

(73) Assignee: Bank of America Corporation, Charlotte, NC (US)

(21) Appl. No.: 13/599,778

(22) Filed: Aug. 30, 2012

(51) Int. Cl. G06Q 20/40; G06Q 30/06

(52) U.S. Cl. 705/26.35

(57) ABSTRACT

According to one embodiment, a system includes an interface and a processor. The interface receives, from a node, an order, the order being associated with a customer and comprising customer information, the customer being associated with the node. The processor caches the order in short-term memory, identifies the customer information from the order, and generates sanctions-screening information, the sanctions-screening information comprising the customer information and a node identifier. The interface communicates, to a sanctions-screening module at a remote site, the sanctions-screening information; receives, from the sanctions-screening module at the remote site, sanctions-screening-analysis results; and communicates, to the node, the sanctions-screening-analysis results.

### TECHNICAL FIELD OF THE INVENTION

This disclosure relates generally to screening financial transactions, and more specifically to economic-sanctions screening of financial transactions.

### BACKGROUND

In certain industries, an entity may perform sanctions screening for another entity and/or determine whether sanctions screening is necessary as part of a broader service. Information related to the other entity's customer may be used for the screening. However, when the entities are in the same industry, performing these services creates unwanted liability.

### SUMMARY OF THE INVENTION

According to certain embodiments of the present disclosure, disadvantages and problems associated with previous systems for providing sanctions screening as part of a broader transaction service may be reduced or eliminated.

According to one embodiment, a system includes a processor and an interface. The interface receives, from a node, an order. The order is associated with a customer and includes customer information. The customer is associated with the node. The processor caches the order in short-term memory. The processor identifies the customer information from the order. The processor generates sanctions-screening information. The sanctions-screening information includes the customer information and a node identifier. The interface communicates, to a sanctions-screening module at a remote site, the sanctions-screening information. The interface receives, from the sanctions-screening module at the remote site, sanctions-screening-analysis results. The interface communicates, to the node, the sanctions-screening-analysis results.

Certain embodiments of the disclosure may provide one or more technical advantages. For example, caching the order in short-term memory and/or having the sanctions-screening analysis performed at a remote site may limit the processing and storage resources needed by the system.

Certain embodiments of the disclosure may also provide one or more economic advantages. For example, having the sanctions-screening analysis performed at a remote site and/or having another party determine whether sanctions-screening analysis should be performed may reduce or eliminate unwanted liability.

Certain embodiments of the present disclosure may include some, all, or none of the above advantages. One or more other technical or other advantages may be readily apparent to those skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example system for facilitating sanctions-screening analysis by a third party at a remote site, according to one embodiment of the present disclosure;

FIG. 2 illustrates an example embodiment of a GUI operable to allow a user to input customer information associated with an order, according to one embodiment of the present disclosure;

FIG. 3 illustrates an example embodiment of a GUI operable to display sanctions-screening analysis results, according to one embodiment of the present disclosure; and

FIG. 4 illustrates an example method for facilitating sanctions-screening analysis by a third party at a remote site, according to one embodiment of the present disclosure.

### DETAILED DESCRIPTION OF THE INVENTION

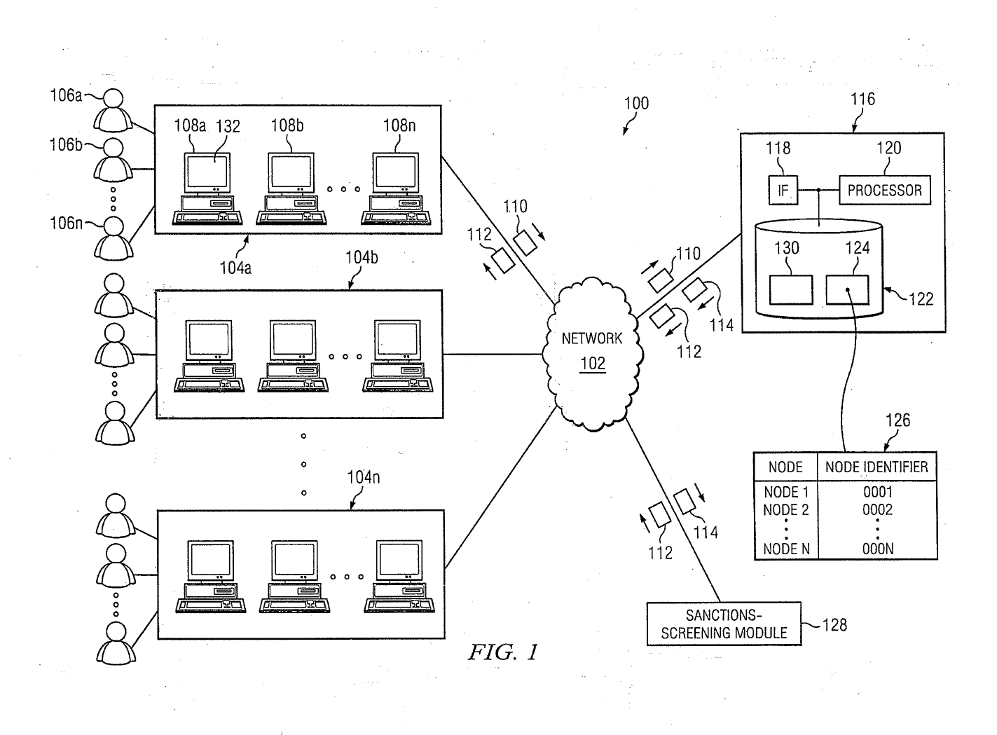

Embodiments of the present disclosure are best understood by referring to FIGS. 1 through 4 of the drawings, like numerals being used for like and corresponding parts of the various drawings.

FIG. 1 illustrates an example system 100 for facilitating sanctions-screening analysis by a third party at a remote site, according to one embodiment of the present disclosure. System 100 performs the analysis based on order 110 that comprises a request to perform sanctions-screening analysis.

System 100 coordinates interactions between nodes 104 and sanctions-screening module 128. Via the coordination, sanctions-screening module 128 performs sanctions-screening analysis on behalf of nodes 104. Transaction module 116 acts as an intermediary between nodes 104 and sanctions-screening module 128 to facilitate the sanctions-screening analysis.

In the illustrated embodiment, system 100 includes a plurality of nodes 104, which each include one or more terminals 108. Customers 106 interact with nodes 104 to create orders 110. Transaction module 116 processes orders 110 and sanctions-screening module 128 performs sanctions-screening analysis using data from orders 110. After the sanctions-screening analysis, transaction module 116 communicates sanctions-screening analysis results 112 to nodes 104.

Network 102 represents any suitable network that facilitates communication between the components of system 100. Network 102 may include any interconnecting system capable of transmitting audio, video, signals, data, messages, or any combination of the preceding. Network 102 may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, any other suitable communication link, including combinations thereof operable to facilitate communication between the components of system 100.

Nodes 104 represent any suitable type of entity in any suitable industry that facilitates transactions for its customers 106. For example, node 104a may be a bank, brokerage house, investment firm, or any other suitable entity. In an embodiment, node 104 facilitates transactions with foreign jurisdictions that may involve sanctions. To complete these transactions, customer 106 may need to be screened for sanctions depending on the transactions.

Customers 106 represent any suitable person or persons and/or any suitable type of entity in any suitable industry that interacts with nodes 104 to complete a transaction. The transaction may be a request to buy or sell foreign currency, for example. Customer 106a may be a person, a group of people, an organization, a business, or any other suitable entity.

Terminals 108 represent any suitable type of interface for placing order 110. Terminals 108 may be operated by a teller, directly by customers 106, or in any other suitable manner. Terminals 108 include any suitable hardware, software, or logic (including a processor) to carry out its reporting operations. Terminals 108 represent any components that may display information and receive information for placing order 110. Terminals 108 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 100 in order to display information received from other components of system 100 and input information to be communicated to other components of system 100. Terminals 108 may further allow a user to request information from other components of system 100 and/or provide information to other components of system 100. Terminal 108 may comprise a user interface, such as a display, a microphone, keypad, or other appropriate terminal equipment usable by a user.

In the illustrated embodiment, terminal 108a includes a graphical user interface (“GUI”) 132 that displays information received from various components in system 100 to a user of terminal 108a and receives input from a user of terminal 108a. For example, GUI 132 displays information received from transaction module 116. As another example, GUI 132 receives information from the user of terminal 108a for use in the sanctions-screening analysis. GUI 132 is generally operable to tailor and filter data entered by and presented to the user. GUI 132 may provide the user with an efficient and user-friendly presentation of information. GUI 132 may comprise a plurality of displays having interactive fields, pull-down lists, and buttons operated by the user. GUI 132 may include multiple levels of abstraction including groupings and boundaries. It should be understood that the term GUI 132 may be used in the singular or in the plural to describe one or more GUIs 132 and each of the displays of a particular GUI 132.

Order 110 includes information related to a request to perform a transaction. Order 110 may be associated with a particular customer 106a and/or a particular node 104a. Information included in order 110 may include general information associated with customer 106a and/or node 104a, information associated with the type of transaction requested, information related to sanctions-screening analysis, and/or any other suitable information. In certain embodiments, order 110 includes customer information, such as the name of customer 106a and/or the address of customer 106a. In certain embodiments, order 110 may include a request to perform sanctions-screening analysis. In certain embodiments, order 110 may include a request to buy and/or sell foreign currency or perform any other suitable transaction. In certain embodiments, information in order 110 may be based on selections or other types of information input at terminals 108 or a particular terminal 108a. In certain embodiments, the selections provided may be chosen from a finite set of possible choices, freeform responses, a non-response (e.g., a blank response or an indication that the answer is unknown), or any other suitable response. Terminal 108 communicates order 110 over network 102 to transaction module 116 or any other suitable location.

Transaction module 116 represents a component that facilitates the interactions between nodes 104 and sanctions-screening module 128 to complete sanction screening. Transaction module 116 may include a network server, any suitable remote server, a mainframe, a host computer, a workstation, a web server, a personal computer, a file, server, or any other suitable device operable to carry out the described operations. In some embodiments, transaction module 116 may execute any suitable operating system such as IBM's zSeries/Operating system (z/OS), MS-DOS, PC-DOS, MAC-OS, WINDOWS, UNIX, OPenVMS, Linux, or any other appropriate operating systems, including operating systems developed in the future. The functions of transaction module 116 may be performed by any suitable combination of one or more servers or other components at one or more locations. In the embodiment where the modules are servers, the servers may be public or private servers, and each server may be a virtual or physical server. The server may include one or more servers at the same or at locations remote from one another. Also, transaction module 116 may include any suitable component that functions as a server.

In certain embodiments, transaction module 116 includes network interface 118, processor 120, and memory 122.

Network interface 118 represents any suitable device operable to receive information from network 102, perform suitable processing of the information, communicate to other devices, or any combination of the preceding. For example, network interface 118 may receive order 110 for a particular customer 106a and node 104a from terminal 108a. Network interface 118 represents any port or connection, real or virtual, including any suitable hardware and/or software, including protocol conversion and data processing capabilities, to communicate through a LAN, WAN, or other communication systems that allow transaction module 116 to exchange information with the components of system 100.

Processor 120 communicatively couples to network interface 118 and memory 122. Processor 120 controls the operation and administration of transaction module 116 by processing information received from network interface 118 and memory 122. Processor 120 includes any hardware and/or software that operates to control and process information. For example, processor 120 caches order 110 in short-term memory, identifies the customer information from order 110, and generates sanctions-screening information 114 using order 110 and information in node data 124. Processor 120 may remove order 110 and/or sanctions-screening information 114 from short-term memory. Removing order 110 and/or sanctions-screening information 114 minimizes the resources needed for transaction module 116 and reduces potential liability by not storing information related to order 110. Processor 120 may be a programmable logic device, a microcontroller, a microprocessor, any suitable processing device, or any suitable combination of the preceding.

Memory 122 stores, either permanently or temporarily, data, operational software, or other information for processor 120. Memory 122 includes any one or a combination of volatile or nonvolatile local or remote devices suitable for storing information. For example, memory 122 may include random access memory (RAM), read only memory (ROM), magnetic storage devices, optical storage devices, database and/or network storage, removable storage media, or any other suitable information storage device or a combination of these devices. While illustrated as including particular modules, memory 122 may include any suitable information for use in the operation of transaction module 116.

In certain embodiments, memory 122 includes management software 130 and node data 124. Management software 130 represents any suitable set of instructions, logic, or code embodied in a non-transitory, computer readable medium and operable to facilitate the operation of transaction module 116. Node data 124 includes node identifiers that transaction module 116 may use to generate sanctions-screening information 114.

Node data 124 includes information used by processor 120 to determine a node identifier for order 110. The node identifier may be determined based on information in order 110 and/or based on where order 110 originated or was communicated from. In certain embodiments, node data 124 includes a data structure 126 that indicates node identifiers for nodes 104. Processor 120 may generate sanctions-screening information 114 using one or more node identifiers, and node identifiers may be used by sanctions-screening module 128 to perform sanctions-screening analysis. Node identifiers may be numbers or letters or any combination of numbers and letters or may have any other suitable format. Node identifiers may be unique identifiers that are unique to each of nodes 104.

Sanctions-screening information 114 represents information that is used to perform sanctions-screening analysis. Sanctions-screening information 114 may be associated with a particular customer 106a and/or a particular node 104a. Sanctions-screening information 114 may include customer information, including a name of customer 106a and an address of customer 106a, and a node identifier associated with node 104a, or any other suitable information for performing sanctions-screening analysis. Transaction module 116 may generate sanctions-screening information 114 using information in order 110, information in data structure 126, or any other suitable information. Transaction module 116 may generate sanctions-screening information 114 in response to determining that order 110 comprises a request to perform sanctions-screening analysis. Sanctions-screening information 114 may be sent over network 102 to sanctions-screening module 128 or any other suitable location.

Sanctions-screening module 128 represents a third-party component for performing sanctions-screening analysis. For example, sanctions-screening module 128 may be a vendor of an entity associated with transaction module 116. Sanctions-screening module 128 may include any combination of hardware, software, firmware, and/or any other suitable components for performing sanctions-screening analysis. In certain embodiments, sanctions-screening module 128 receives sanctions-screening information 114, performs sanctions-screening analysis, generates sanctions-screening-analysis results 112, and communicates sanctions-screening-analysis results 112 to transaction module 116. Sanctions-screening module 128 may perform sanctions screening analysis by comparing sanctions-screening information 114 to information in a database, such as a database of people and/or entities subject to sanctions. For example, sanctions-screening module 128 may determine that the name of customer 106a in customer information 114 matches the name of a person in a database of people subject to economic sanctions. Based on the match, sanctions-screening module 128 may generate sanctions-screening-analysis results 112 indicating a match and may communicate sanctions-screening-analysis results 112 to transaction module 116. Sanctions-screening module 128 may retain, in memory, sanctions-screening analysis results 112 that indicate a match and/or may retain other information related to those results. Economic sanctions, or any other type of sanctions, identified by sanctions-screening module may be sanctions enforced by a country or other entity with authority over node 104a.

In an example embodiment of operation, a user of terminal 108a, such as a teller, inputs information at terminal 108a based on a request by customer 106a to buy or sell foreign currency and indicates that sanctions-screening analysis should be performed. Based on the input information, order 110 is communicated by network 102 to transaction module 116. Order 110 includes customer information including a name of customer 106a and an address of customer 106a. Transaction module 116 receives order 110 at network interface 118. Processor 120 determines that order 110 includes a request to perform sanctions-screening analysis. Processor 120 caches order 110 in short-term memory, identifies the customer information from order 110, and generates sanctions-screening information 114. Sanctions-screening information 114 includes the customer information and a node identifier that processor 120 accesses from data structure 126 in node data 124. Processor 120 performs these tasks by executing non-transitory computer-readable medium comprising logic in management software 130. Processor 120 caches sanctions-screening information 114 in short-term memory. Processor 120 may also cache other suitable information identified in and/or generated from information in order 110 and that transaction module 116 may use to perform the described operation. Network interface 118 communicates sanctions-screening information 114 to sanctions-screening module 128 using network 102. Sanctions-screening module 128 performs sanctions-screening analysis based on sanctions-screening information 114 and communicates sanctions-screening-analysis results 112 to network interface 118 of transaction module 116 using network 102. Network interface 118 of transaction module 116 communicates sanctions-screening-analysis results 112 to node 104a. For example, network interface 118 may communicate sanctions-screening-analysis results 112 using GUI 132 at terminal 108a. A user of terminal 108a may input a response to sanctions-screening-analysis results 112, such as an acknowledgement of the results or a termination of the transaction process. Node 108a may communicate the response to network interface 118 of transaction module 116 using network 102. Processor 120 removes order 110 and sanctions-screening information 114 from short-term memory. Processor 120 may also remove other information from short- term memory because the information is no longer needed by transaction module 116. In an additional example embodiment of operation, a user of terminal 108a, such as a teller, inputs information at terminal 108a based on a request by customer 106a to buy or sell foreign currency and indicates that sanctions-screening analysis should be performed. Based on the input information, order 110 is communicated by network 102 to transaction module 116. Order 110 includes customer information including a name of customer 106a and an address of customer 106a. Transaction module 116 receives order 110 at network interface 118. Processor 120 determines that order 110 includes a request to perform sanctions-screening analysis. Processor 120 caches order 110 in short-term memory, identifies the customer information from order 110, and generates sanctions-screening information 114. Sanctions-screening information 114 includes the customer information and a node identifier that processor 120 accesses from data structure 126 in node data 124. Processor 120 performs these tasks by executing non-transitory computer-readable medium comprising logic in management software 130. Network interface 118 communicates sanctions-screening information 114 to sanctions-screening module 128 using network 102. Transaction module 116 may remove customer information from memory after communicating sanctions-screening information 114 to sanctions-screening module 128. Sanctions-screening module 128 performs sanctions-screening analysis based on sanctions-screening information 114 and communicates sanctions-screening-analysis results 112 to network interface 118 of transaction module 116 using network 102. Network interface 118 of transaction module 116 may communicate sanctions-screening-analysis results 112 to node 104a. For example, network interface 118 may communicate sanctions-screening-analysis results 112 using GUI 132 at terminal 108a.

A component of system 100 may include an interface, logic, memory, and/or any other suitable element. An interface receives input, sends output, processes the input and/or output, and/or performs other suitable operations. An interface may comprise hardware and/or software. Logic performs the operations of the component, for example, executes instructions to generate output from input. Logic may include hardware, software, and/or other logic. Logic may be encoded in one or more nontransitory medium, such as a computer readable medium or any other tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 100 without departing from the scope of the invention. The components of the systems and apparatuses may be integrated or separated. For example, transaction module 116 may be integrated directly into terminal 108a. In embodiments with this configuration, transaction module 116 may exclude network interface 118. Rather, a user of terminal 108a may input information, such as order 110, directly into transaction module 116. Moreover, the operations of the systems and apparatuses may be performed by more, fewer, or other components. Additionally, operations of the systems and apparatuses may be performed using any suitable logic comprising software, hardware, and/or other logic.

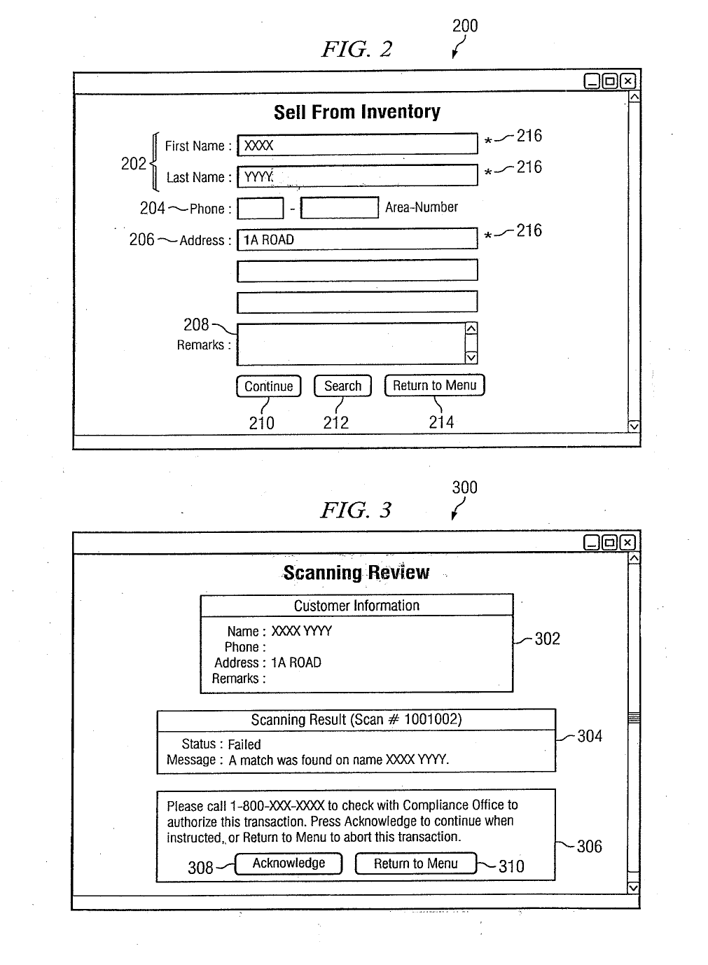

FIG. 2 illustrates an example embodiment of GUI 200 operable to allow a user to input customer information associated with order 110, according to one embodiment of the present disclosure. In certain embodiments, GUI 200 may be an example of GUI 132 of FIG. 1. GUI 200 may appear on terminal 108a in response to a request from customer 106a to buy or sell foreign currency or perform any other suitable transaction. Name-entry fields 202 may prompt and allow a user to input first and last names of customer 106a. For example, in the illustrated example, a user has input a first name “XXXX” and a last name of “YYYY.” Phone-number-entry field 204 may prompt and allow a user to input a phone number of customer 106a. Address-entry field 206 may prompt and allow a user to input an address of customer 106a. For example, in the illustrated example, a user has input an address of “1A Road.” Remarks-entry field 208 may prompt and allow a user to input remarks. Required-field indicators 216 may indicate required fields. Continue button 210 may allow a user to continue to the next screen. Search button 212 may allow a user to find additional information after inputting partial information. For example, a user may input only a last name and search for other customer information based on the last name. Return-to-menu button 214 may allow a user to return to a previous menu, for example if a user had accidentally indicated that customer 106a would like to buy foreign currency.

Modifications, additions, or omissions may be made to GUI 200 without departing from the scope of the invention. For example, GUI 200 may include more or fewer fields and/or buttons.

FIG. 3 illustrates an example embodiment of GUI 300 operable to display sanctions-screening analysis results 112, according to one embodiment of the present disclosure. In certain embodiments, GUI 300 may be an example of GUI 132 of FIG. 1. GUI 300 may be displayed in response to a user inputting customer information and pressing continue button 210 on GUI 200. Customer-information display 302 may display the information input by the user on the previous screen, GUI 200. For example, in the illustrated example, customer-information display 302 displays the name of “XXXX YYYY” and the address of “1A Road,” indicating the customer information input by the user at GUI 200. Scanning-result display 304 may display information related to sanctions-screening-analysis results 112. For example, in the illustrated example, scanning-result display 304 indicates a “Status” of “Failed” and a “Message” of “A match was found on name XXXX YYYY.” Instructions display 306 may include instructions for a user and may include buttons for allowing the user to proceed. For example, in the illustrated example, instructions display 306 includes the instructions “Please call 1-800-XXX-XXXX to check with Compliance Office to authorize this transaction. Press Acknowledge to continue when instructed, or Return to Menu to abort this transaction.” In response to this message, a teller at terminal 108a may contact a compliance office associated with node 104a. A compliance manager in the compliance office may access information retained at sanctions-screening module 128 to decide whether to authorize or deny the transaction and may give appropriate instructions to the teller. In the illustrated example, instructions display 306 also includes acknowledge button 308 and return-to-menu button 310. Pressing acknowledge button 308 may allow a user to proceed to execute a transaction. Pressing return-to-menu button 310 may allow a user to return to a previous menu screen without placing a transaction. In certain embodiments, sanctions-screening-analysis results 112 may be lost as soon as a user exits GUI 300, for example, when a user presses either the acknowledge button 308 or the return-to-menu button 310, when the user closes the browser displaying GUI 300, or when the connection to network 102 and/or transaction module 116 is dropped.

Modifications, additions, or omissions may be made to GUI 300 without departing from the scope of the invention. For example, GUI 300 may include additional or less information and/or buttons arranged in different displays.

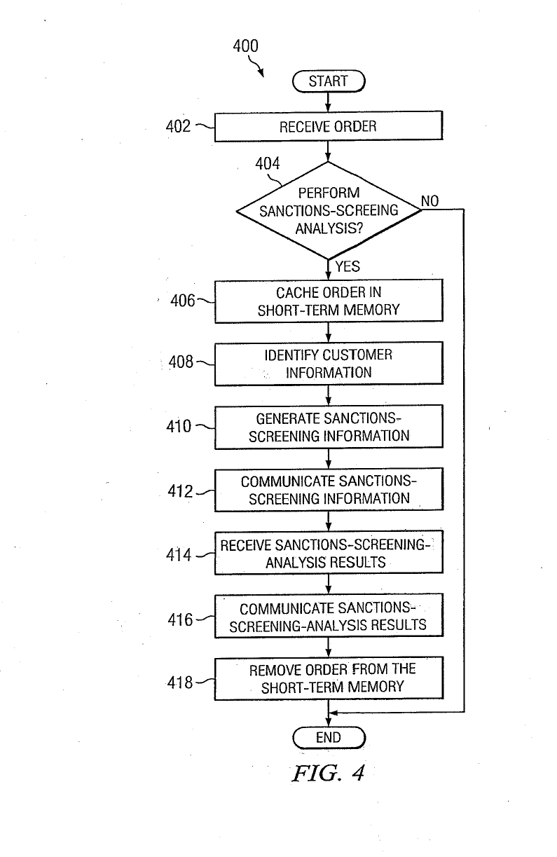

FIG. 4 illustrates an example method 400 for facilitating sanctions-screening analysis by a third party at a remote site, according to one embodiment of the present disclosure.

Transaction module 116 may receive order 110 at step 402. Specifically, network interface 118 of transaction module 116 may receive order 110. Order 110 may be received from node 104a, may be associated with customer 106a, and may comprise customer information. Customer 106a may be associated with node 104a. Customer information may include, for example, a name of customer 106a and an address of customer 106a. Order 110 may be associated with a request by customer 106a to conduct a transaction involving foreign currency and may include a request to perform sanctions-screening analysis. For example, a teller may have input order information at terminal 108a indicating that customer 106a would like to buy foreign currency and the teller may have indicated that sanctions-screening analysis should be performed, resulting in order 110 being sent to transaction module 116. Order 110 may be communicated from node 104a to transaction module 116 by network 102.

Transaction module 116 may determine whether order 110 includes a request to perform sanctions-screening analysis at step 404. For example, processor 120 may determine, based on information included in order 110, that a teller inputting order 110 requested that sanctions-screening analysis be performed and may continue to step 406. Alternatively, processor 120 may determine that order 110 does not include a request to perform sanctions-screening analysis and, as a result, the method may end. In either case, transaction module 116 does not perform the initial determination whether sanctions-screening analysis should be performed. When an entity associated with transaction module 116 is distinct from an entity associated with node 104a but is in the same industry as the entity associated with node 104a, making the initial determination of whether to perform economic-sanctions screening may subject the entity associated with transaction module 116 with unwanted liability. Having another party, such as a teller at node 104a, determine whether sanctions-screening analysis should be performed, as shown in method 400, may reduce or eliminate unwanted liability for an entity associated with transaction module 116.

Transaction module 116 may cache order 110 in short-term memory at step 406. This may allow transaction module 116 to store order 110 for long enough to process information in order 110 as required by other steps of method 400 while also limiting the storage resources needed by transaction module 116 and/or reducing or eliminating unwanted liability.

At step 408, transaction module 116 may identify customer information from order 110. For example, processor 120 may identify information within order 110, such as, for example, a name of customer 106a and an address of customer 106a, as being customer information.

Transaction module 116 may generate sanctions-screening information 114 at step 410. Sanctions-screening information 114 may include customer information and a node identifier. Processor 120 may generate sanctions-screening information 114 by appending a node identifier to the customer information. The node identifier may be an identifier that is unique to node 104a from which transaction module 116 received order 110. Transaction module 116 may access the node identifier using data structure 126 of node data 124. Transaction module 116 may do so by looking up the node identifier in data structure 126 based on other information that transaction module 116 has access to. The other information may be information associated with node 104a in order 110 or other information indicating where order 110 originated.

Transaction module 116 may communicate sanctions-screening information 114 to sanctions-screening module 128 at step 412. More specifically, network interface 118 of transaction module 116 may communicate sanctions-screening information 114 to sanctions-screening module 128 using network 102. Sending sanctions-screening information 114 to sanctions-screening module 128 may allow for sanctions-screening analysis to be performed at sanctions-screening module 128 by a third party. Having the sanctions-screening analysis performed by another party may reduce or eliminate unwanted liability.

Transaction module 116 may receive sanctions-screening-analysis results 112 at step 414. More specifically, network interface 118 of transaction module 116 may receive sanctions-screening-analysis results 112 from sanctions-screening module 128 by use of network 102. Sanctions-screening-analysis results 112 may include results of sanctions-screening analysis performed at sanctions-screening module 128 based on information in sanctions-screening information 114. For example, sanctions-screening-analysis results 112 may indicate that a match was found for the name of customer 106a.

Transaction module 116 may communicate sanctions-screening-analysis results 112 to node 104a at step 416. Specifically, network interface 118 may communicate sanctions-screening-analysis results 112 to node 104a using network 102. Sanctions-screening-analysis results 112 may be displayed on GUI 132 of terminal 108a, for communication to a teller or other user.

Transaction module 116 may remove order 110 from short-term memory at step 418. Additionally or alternatively, transaction module 116 may remove customer information and/or sanctions-screening information 114 from memory. Removing one or more of these items may limit the storage resources needed by transaction module 116 and/or reduce or eliminate unwanted liability.

Modifications, additions, or omissions may be made to method 400 disclosed herein without departing from the scope of the invention. The methods may include more, fewer, or other steps. For example, the method may exclude step 404 and may assume that sanctions-screening analysis should be performed for all orders 110. For example, in some embodiments, transaction module 116 may only receive order 110 when a teller or other user has indicated that sanctions-screening analysis should be performed. As additional examples, transaction module 116 may cache sanctions-screening information 114 in short-term memory, receive information indicating a teller-input response to sanctions-screening-analysis results 112, and remove sanctions-screening information 114 from short-term memory. Additionally, steps may be performed in parallel or in any suitable order. For example, transaction module 116 may remove, from short-term memory, order 110, sanctions-screening information 114, and/or any other suitable information, before receiving sanctions-screening-analysis results 112 at step 414.

According to certain embodiments of the present disclosure, disadvantages and problems associated with previous systems for providing sanctions screening as part of a broader transaction service may be reduced or eliminated.

Certain embodiments of the disclosure may provide one or more technical advantages. For example, caching order 110 in short-term memory and/or having the sanctions-screening analysis performed at a remote site may limit the processing and storage resources needed by the system.

Certain embodiments of the disclosure may also provide one or more economic advantages. For example, having the sanctions-screening analysis performed at a remote site and/or having another party determine whether sanctions-screening analysis should be performed may reduce or eliminate unwanted liability.

Certain embodiments of the present disclosure may include some, all, or none of the above advantages. One or more other technical or other advantages may be readily apparent to those skilled in the art from the figures, descriptions, and claims included herein.

Although the present disclosure has been described with several embodiments, diverse changes, substitutions, variations, alterations, and modifications may be suggested to one skilled in the art, and it is intended that the invention encompass all such changes, substitutions, variations, alterations, transformations, and modifications as fall within the spirit and scope of the appended claims.

What is claimed is:

1. A system, comprising:
an interface operable to receive, from a node, an order, the order being associated with a customer and comprising customer information, the customer being associated with the node;
a processor operable to:
cache the order in a short-term memory;
identify the customer information from the order; and
generate sanctions-screening information, the sanctions-screening information comprising the customer information and a node identifier;
wherein the interface is further operable to:
communicate, to a sanctions-screening module at a remote site, the sanctions-screening information;
receive, from the sanctions-screening module at the remote site, sanctions-screening-analysis results; and
communicate, to the node, the sanctions-screening-analysis results.

2. The system of claim 1, wherein the customer information comprises:
a name of the customer; and
an address of the customer.

3. The system of claim 1, wherein the node identifier is an identifier that is unique to the node.

4. The system of claim 1,
wherein the order is associated with a request by the customer to conduct a transaction involving foreign currency and comprises a request to perform sanctions-screening analysis; and
wherein the processor is further operable to determine that the order comprises the request to perform sanctions-screening analysis.

5. The system of claim 1 wherein the sanctions-screening-analysis results are related to sanctions enforced by an entity with authority over the node.

6. The system of claim 1, wherein the processor is further operable to remove the order from the short-term memory after communicating, to the sanctions-screening module at a remote site, the sanctions-screening information.

7. The system of claim 1, wherein the processor is further operable to:
receive a decision from the node, the decision indicating whether to abort or proceed with a transaction process; and
remove the order from the short-term memory after receiving the decision from the node.

8. A non-transitory computer-readable medium comprising logic, the logic, when executed by a processor, operable to:
receive, from a node, an order, the order being associated with a customer and comprising customer information, the customer being associated with the node;
cache the order in a short-term memory;
identify the customer information from the order;
generate sanctions-screening information, the sanctions-screening information comprising the customer information and a node identifier;
communicate, to a sanctions-screening module at a remote site, the sanctions-screening information;
receive, from the sanctions-screening module at the remote site, sanctions-screening-analysis results; and
communicate, to the node, the sanctions-screening-analysis results.

9. The computer-readable medium of claim 8 wherein the customer information comprises:
a name of the customer; and
an address of the customer.

10. The computer-readable medium of claim 8, wherein the node identifier is an identifier that is unique to the node.

11. The computer-readable medium of claim 8,
wherein the order is associated with a request by the customer to conduct a transaction involving foreign currency and comprises a request to perform sanctions-screening analysis; and
wherein the logic, when executed by a processor, is further operable to determine that the order comprises the request to perform sanctions-screening analysis.

12. The computer-readable medium of claim 8, wherein the sanctions-screening-analysis results are related to sanctions enforced by an entity with authority over the node.

13. The computer-readable medium of claim 8, wherein the logic, when executed by a processor, is further operable to remove the order from the short-term memory after communicating, to the sanctions-screening module at the remote site, the sanctions-screening information.

14. The computer-readable medium of claim 8, wherein the logic, when executed by a processor, is further operable to:
receive a decision from the node, the decision indicating whether to abort or proceed with a transaction process; and
remove the order from the short-term memory after receiving the decision from the node.

15. A method, comprising:
receiving, from a node, an order, the order being associated with a customer and comprising customer information, the customer being associated with the node;
caching the order in a short-term memory;
identifying the customer information from the order;
generating, at a processor, sanctions-screening information, the sanctions-screening information comprising the customer information and a node identifier;
communicating, to a sanctions-screening module at a remote site, the sanctions-screening information;
receiving, from the sanctions-screening module at the remote site, sanctions-screening-analysis results; and
communicating, to the node, the sanctions-screening-analysis results.

16. The method of claim 15, wherein the customer information comprises:
a name of the customer; and
an address of the customer.

17. The method of claim 15, wherein the node identifier is an identifier that is unique to the node.

18. The method of claim 15,
wherein the order is associated with a request by the customer to conduct a transaction involving foreign currency and comprises a request to perform sanctions-screening analysis; and
wherein the method further comprises determining that the order comprises the request to perform sanctions-screening analysis.

19. The method of claim 15, wherein the logic, when executed by a processor, is further operable to remove the order from the short-term memory after communicating, to the sanctions-screening module at the remote site, the sanctions-screening information.

20. The method of claim 15, further comprising:
receiving a decision from the node, the decision indicating whether to abort or proceed with a transaction process; and
removing the order from the short-term memory after receiving the decision from the node.
